(19) United States
(12) Patent Application Publication
(10) Pub. No.: US 2004/0064985 A1
(43) Pub. Date: Apr. 8, 2004

(54) Frame panel system for suspending panels in rooms

(76) Inventor: Friedheim Lenz, Leipzig (DE)

Correspondence Address: WILLIAM COLLARD, COLLARD & ROE, P.C., 1077 NORTHERN BOULEVARD, ROSLYN, NY, 11576, US

(21) Appl. No.: 10/398,349

(22) PCT Filed: Oct. 5, 2001
(86) PCT No.: PCT/DE01/03837

(30) Foreign Application Priority Data
Oct. 5, 2000 (AT) GM740/2000

(51) Int. Cl. G09F 11/00

(52) U.S. Cl. 40/490

(57) ABSTRACT

The invention relates to a frame panel system (1) for suspending sliding panels that comprise a frame (8) and a fabric covering (6) or a board (6′). The panels can be freely displaced with respect to one another in parallel, thereby producing color effects or optical effects. The panels are movably received in a guide rail (2) by means of a special fixture (3). The inventive system is mainly used for window decorations, blackout panels and sun protection devices, as well as for room dividers and sliding elements for paneling shelves, wardrobes, cupboards or niches.

This invention deals with a frame-panel system for indoor suspension of panels and in particular with the frame of the panels and the suspension.

In prior art such system are known from the publication G 90 05 068.1. This publication shows a poster holding device with a base plate and a wraparound frame which has at least one flexible fixing clip with the base plate projecting over the frame edge and the frame having a clamping device stationary to the base plate where the fixing clip provided with at least one spring leg, is prestressed so hat the spring leg constantly presses against the base plate. Hence it follows that the poster holding device consists of a base plate and a frame fringing the base plate with spring legs and fixing clips being provided in the frame which prestress the poster to be clamped. The spring leg shows spikes and tongues with sharp-edged, tapered ends cutting into the poster to hold the edges of the poster. The prestress of the poster is thus be generated by the interaction of the leg spring and the fixing clip in the frame of the poster holding device. In addition a base plate has been provided the poster is resting on to prevent any crinkling and buckling.

The clamping device in the frame is of rather complicated design and, of course, thus incurs relatively high manufacturing costs. In addition this poster holding device is designed for paper posters only, because the sharp-edged spikes of the clamping device cannot find hold in woven textile material. No reference is made in this publication as of whether be posters are slidable. All in all, it is relatively costly and complicated to manufacture the poster holding device as given in this publication so that this method cannot be used for textile walls of several square meters.

So, it is the object of this invention to provide a indoor frame-panel system which is slidable, easy in design and cost-effective when it comes to manufacture.

This object is tackled by the characteristics of the main claim.

Other essential features of this invention can be gathered from the sub-claims.

The indoor frame-panel system according to this invention consists of minimum one holding device fixed to a frame with the holding device sliding in minimum one rail and the frame having a cross-sectional profile taking up, on the one hand, one angle at the ends of the individual panel sides, and, on the other, a fabric covering and/or a panel in a grove provided that purpose.

It is advantageous to use an angle of solid material with the external dimensions being the internal dimensions of the cross-sectional profile. It is also advantageous to glue one leg in the cross-sectional profile and the screw the other leg of the angle using a screw provided for that purpose. For this the end of the frame profile has a drilled hole located exactly over a tapped hole in the other leg of the angle when pushed together.

To make it possible that the panels according to this invention can be used on walls having a certain inclination it is advantageous to provide at least one guide rail at two sides on the top and bottom of the panels where the panel holding device can run.

It is also advantageous for the frame-panel system for the suspension and shifting of panels that the profiled ledges of the panel frame are mitered at their ends. The outer edges of the frame have a groove formed by a strap where the edges of the fabric covering or a suitable panel is inserted. It has a favourable effect to apply a fleeced strip on one side of the frame where the barbs of a barbed strap can hook in.

The frame for the covering should be made of wood, plastic material or metal.

It is advantageous for the manufacture of the frame according to this invention to use newly developed profiled ledges which are hollow inside so that a suitable angle can be inserted into the hollow part. For a rectangular frame the angles are rectangular.

It is advantageous to fix a holding device at minimum one side of the stretching frame, which can be of different design. It is of special advantage to provide a cylindrical head at one end of the holding device of the panel frame, which has at least one plastic enclosure. The diameter of the cylindrical head depends on the mounting location of the holding device, i.e. whether the holding device is mounted at the upper side or lower side of the panels. Important for pressure distribution at the cylindrical head in the guiding groove of the guide rail is a chamfer at the lower edge of the cylindrical bolt head.

Another advantageous design of the holding device is characterized in that this holding device shows no cylindrical bolt head but a roller mechanism with minimum two rollers sliding and rolling respectively in a guide rail.

It is advantageous in this respect to use commercially available guide rails which can have any cross-sectional profile, e.g. round or rectangular. Advantageously one end of the holding device should be fixed to the side of the frame by bolting. For this the bolt is inserted through a sleeve in a casing, and the sleeve can be laterally shifted within the holding device casing with the help of an adjusting screw. This makes it possible to adjust the panels within certain limits and ensure perpendicularity and soft running.

The following gives a more detailed description of this invention based on drawings. It shows:

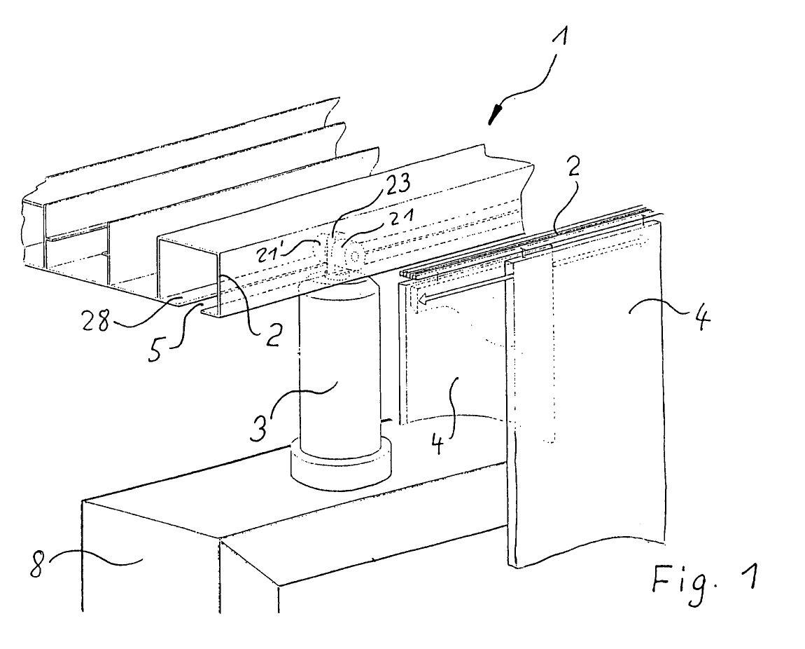

FIG. 1 The frame-panel system according to this invention with two guide rails (2, 2′), a holding device (3) and the panels to be shifted (4) as an exploded view;

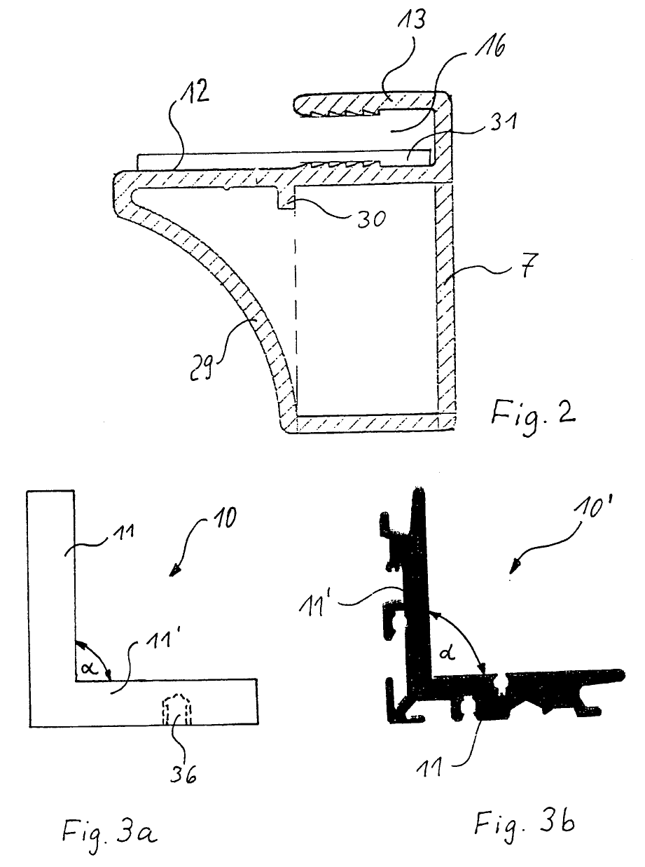

FIG. 2 Cross section of the profiled ledge (7) according to this invention (7):

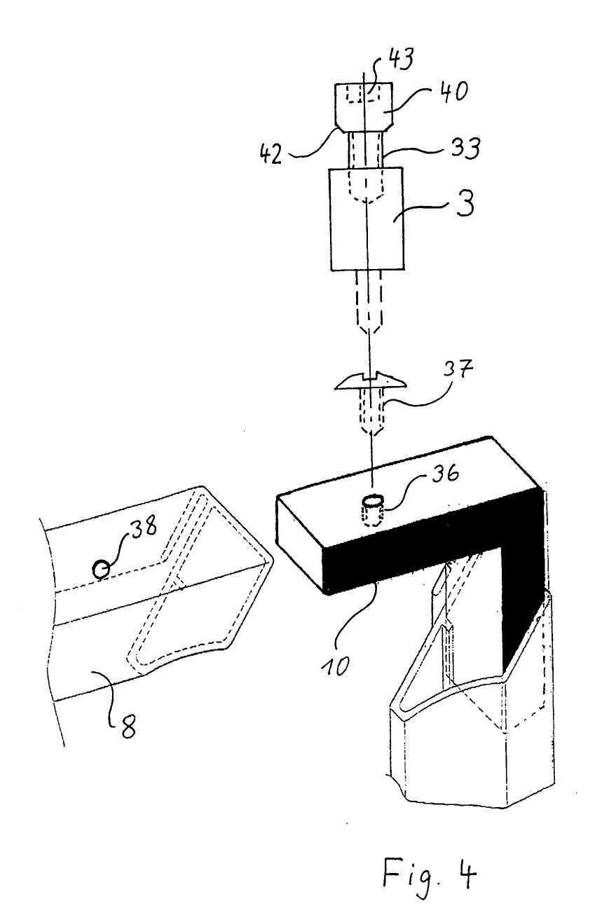

FIG. 3a Side view of an angle (10) with the legs (11, 11′) vertically arranged on top each other.

FIG. 3b Side view of another embodiment of the angle (10′);

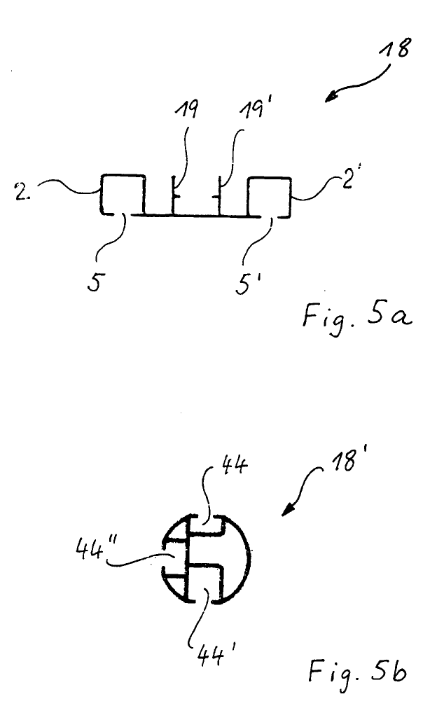

FIG. 4 An exploded view of a corner joint of the frame (8) with an angle (10) of solid material;

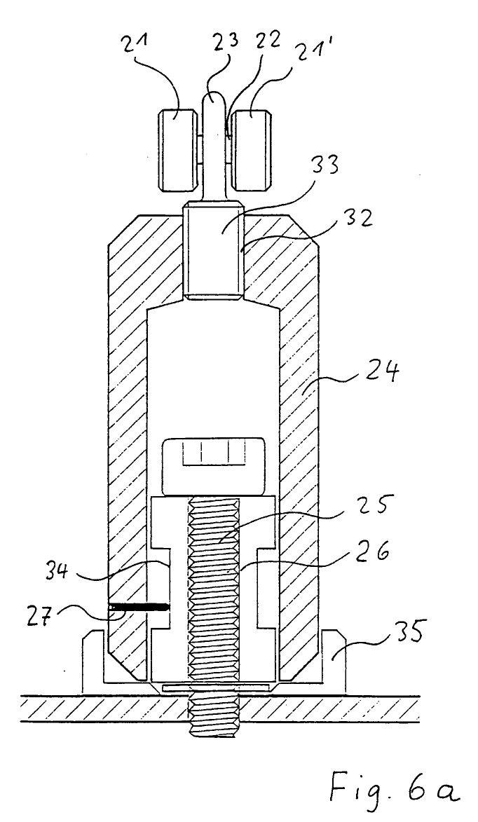

FIG. 5a Cross section of two parallel guide rails (2, 2′);

FIG. 5b Cross section of a guide rail (18′) with a round cross-sectional profile and rectangular guiding grooves (44, 44′, 44″);

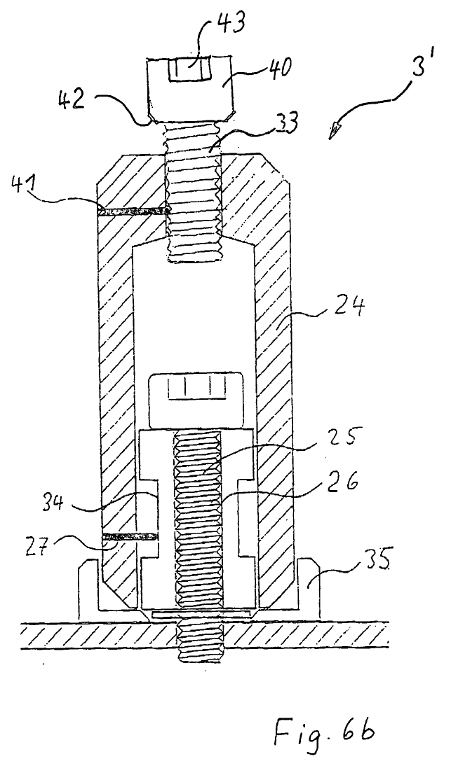

FIG. 6a Sectional view of the holding device (3) mounted on one side of the panel frame (8);

FIG. 6b Another embodiment of the holding device (3′) mounted on one side of the panel frame (8)

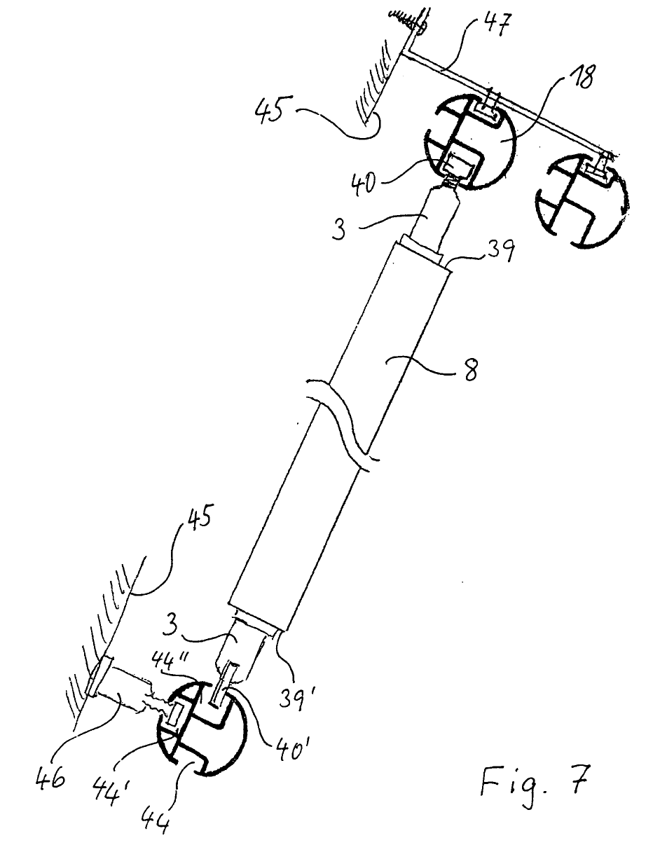

FIG. 7 A schematic side view of a panel according to this invention, the frame (8) of which being arranged on an inclined wall (45) in two slide rails (2, 2′):

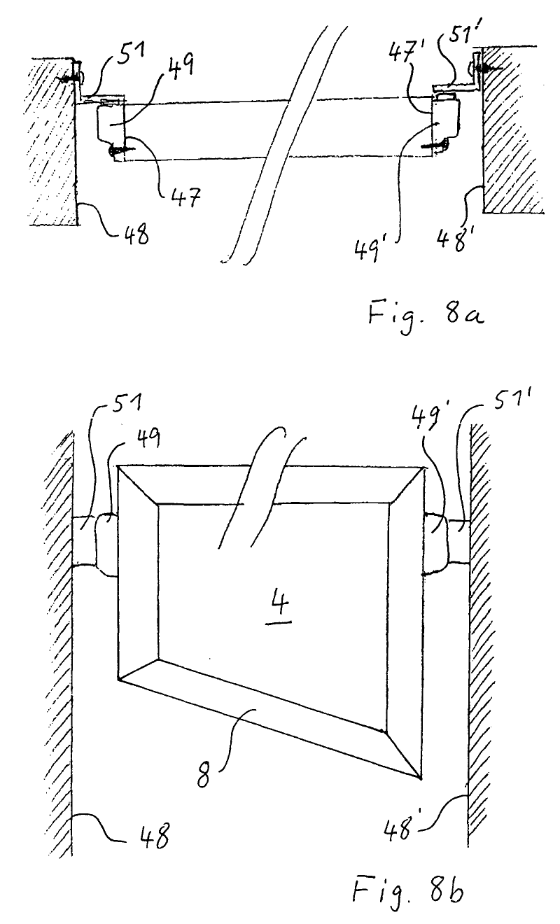

FIG. 8a Top view showing schematically the panel frame (8) with magnets (49, 49′) fixed on its sides (50, 50′);

FIG. 8b Schematic front view of the panel frame (8) with two magnets (49, 49′) forming a magnetic bond by magnetic material.

FIG. 1 is an explosive view of the frame-panel system 1. The required number of the commercially available guide rails (2, 2′) are usually fastened on the ceiling of a room using suitable bolts not further specified here. The rails can also be fastened on the wall using angular supports or brackets which needs no further explanation. The hollow guide rails (2, 2′) are naturally arranged in parallel. Depending on the need several guide rails can be arranged side by side so that in principle a multitude of parallel guide rails lay side by side. Thus, a multitude of different panels can be suspended in the room and relatively shifted to each other. A slot 5 is provided at the underside of the guide rails 2, 2′ with a so-called bearing block 23 of the holding device 3 projecting into so that the bearing block 23 is guided by the edges of slot 5. The rollers 21, 21′ of the holder move along the inner surface of the angled section 28 of the guide rail 2. The holding device 3 constitutes the connection between the guide rail 2 and the frame 8 of the panels 4 to be shifted. The holding device 3 is further specified below. The bearing block 23 is fixed at the casing at one end of the holding device. The other end of the holding device 3 can be disconnected from the frame 8 of the panels 4. The number of holding devices 3 at the frame depends on the frame size and weight respectively of all panels 4.

Because there are several adjacent guide rails 2, 2′ it is easily possible to shift a multitude of panels 4 against each other.

FIG. 2 shows the cross section of a profiled ledge 7 according to this invention. The profiled ledge which is preferably made of aluminum is a long stretched-out hollow rod with the three sides arranged at right angles to each other and an curved side 29, which apart from its stabilizing function also serves for giving the profiled ledge a more elegant appearance. The profiled ledge 7 has a stem 30 provided inside projecting rectangularly into the interior space of the profiled ledge. The presence of the stem 30 causes the formation of a rectangle in the interior of the profiled ledge into which a angle 10, 10′ is pushed in which exactly fits the space. A strap 13 spans over one side of the hollow profile which forms a U-groove 16 with one side of the profiled ledge 7. In this embodiment the inner surfaces of the U-groove 16 have saw-tooth profiles largely preventing the inserted fabric covering 6 and/or panel 6′ of any material from getting out of place. One internal surface of the groove 16 is partially or fully covered with a fleeced strap 31. In this embodiment the fleeced strip 31 is wider then the depth of the U-groove 16 so that the fleeced strip 31 serves as holding surface of the frame 8. Inserting the edge of the fabric 6 into the groove 16 has the major advantage that the entire panel 4 is given a perfect appearance because the edges of the fabric 6 are not visible. In addition to the fabric 6 a panel 6′ can be inserted in the groove 16 at the same time or individually, which can be made of acryl glass or plywood.

FIG. 3a gives the side view of an angle 10 of solid material. The angle 10 has two legs 11, 11′ positioned at right angles to each other, which have a smooth surface. The legs 11, 11′ of solid material have preferably an angle α 90°, one of the legs 11 has a tapped hole 36 at a certain point which is in mesh with a screw not shown here. The cross section of the legs 11, 11′ depends on the cross section of the frame profile 7, i.e. when the receiving part of the frame profile 7 is rectangular, the cross section of the legs 11, 11′ must be rectangular, too.

FIG. 3b is another embodiment of the angle 10′ as a side view. This angle 10′ also has two legs 11, 11′ positioned at right angles to each other which also have a smooth surface inside with an opposed structured surface improving the stability of the angular profile, on the one hand, and providing different fixing possibilities, on the other, to properly fit together the joints of the profiled ledges 7, 7′.

FIG. 4 is an exploded view of the corner joint of the frame. The ends of the two profiled ledges 7, 7′ are mitered, i.e. at an angle of 45° to the longitudinal axis of the profiled ledge 7, 7. As described above a leg 11 of an angle 10 is inserted into the rectangular hollow body, of the profiled ledge 7, 7′ and fixed there. The leg showing downwards in this view is fastened by gluing. The other right-angled leg 11′ of angle 10 is pushed into the other adjacent profiled ledge 7′ until the miters of the ends of the profiled ledge 7, 7′ meet. Leg 11′ of angle 10 has at a certain point a tapped hole 36 meshing with a screw thread 37. Leg 11′ is inserted in the profiled ledge 7′ so that the drilled hole 38 at the end of the profiled ledge 7′ and the tapped hole 36 are exactly on top of each other. A bolt 37 or the thread bolt 33 of the holding device 3 reaches through the recess 38 and is screwed in the tapped hole. Any type of bolt 37 can be used and in particular the head of this bolt 37.

FIG. 5a schematically shows the cross section of a profiled ledge with two guide rails 2, 2′. The guide rails 2, 2′ have a slot 5, 5′ on its bottom where a bearing block 23 of the holding device 3, which is not shown here, engages. Between the two guide rails 2, 2′ there are two webs 19, 19′ at right angles to the face of the guide rails 2, 2′. The webs 19, 19′ give the guide rails torsional strength on the one hand and make it possible to absorb the pressure of a screwing to avoid any distortion of the guide rails.

FIG. 5b is another example of a conventional guide rail 18′. The cross section of this guide rail 18′ is mainly round and has long stretched-out grooves 44, 44′, 44″ were roller bearings or other sliding elements are guided.

FIG. 6a is a sectional view of the holding device 3. Holding device 3 consists of a casing 24 representing in this embodiment a cylinder open at its bottom. The closed section of the cylinder shows a tapped hole 32 with an engaging threaded stem 33 which is firmly connected with the bearing block 23. An axis 22 runs through the bearing block 23 taking up two rollers 21, 21′ at its ends. In the lower part of the cylindrical casing 24 there is a sleeve 26 showing a wide groove 34 on its surface. The groove 34 is connected with a adjusting screw 27 for adjusting the panels 4. Inserted through the drilled hole of the sleeve 26 is a bolt 25 the thread of which meshing with a tapped hole in the frame 8. To give the frame 8 of the panels 4 a firm hold a plate disk 35 has been arranged at the lower end of the casing 24 which exactly encloses the casing 24.

FIG. 6b is another embodiment of the holding 3′. In order to avoid repeats the differences between this holding device 3′ and holding device 3 are explained here only. At the upper end of the casing 24 a threaded stem 33 is screwed into the tapped hole 32, at the one end of which a cylindrical bolt head 40 is arranged. The cylindrical bolt head 40 has a hexagon recess 43 on its upper side into which a suitable Allan key is inserted to adjust the holding device 3. For uniform distribution of pressure inside the guiding groove on the cylindrical bolt head 40 and improvement of the slidability of the cylindrical bolt head 40, the cylindrical bolt head 40 has a chamfer 42 with an angle of 45° at the end showing to the threaded stem 33. The cylindrical bolt head is covered with plastic material while the rest of the bolt is made of metal. In certain applications a plastic bolt is sufficient. At one side of the tapped hole 32 another tapped hole has been provided in casing 24 where a retaining bolt, a grub screw preferably, is screwed in and locks the threaded stem 33.

FIG. 7 is a side view of the panel frame 8 on an inclined wall 45. Special holding devices 46 are provided on the inclined wall 45 meshing with a groove of the conventional round guide rail 18′ and thus holding the guide rail in its position. At the uppers side 39 of the frame 8 two round guide rails 18′ are fastened in parallel to an angular holder 47. The angular holder 47 is fasted on the wall 45 with suitable means. The cylindrical bolt head 40 projects into the groove 44′ of the round guide rail 18′ and is guided along the supporting surfaces of groove 44′. As described above the holding device 24 is fastened to one side 39 of the panels 4 of the frame 8. At the lower side 39′ of the frame 8 of the panels an identical holding device 3 as can be found at the upper side 39, has been provided which only differs insofar that the cylindrical bolt head 40′ has a smaller diameter than the cylindrical bolt head 40 in the upper groove 44′. The holders 46, 47 shown here are just applications of an advantageous holding device of the guide rails 18, 18′.

FIG. 8a is a schematic top view of a panel 4 arranged between two brackets (48, 48′) or girders. Such examples can be found with special panels such as triangles or polygons. At the sides of the panel frame 8 magnetic holders with the magnets 49, 49′ are arranged and fixed with suitable means by way of screwing or gluing. For making a magnetic bond a ferromagnetic material 51, 51′ made of iron is needed. The magnet and ferromagnetic material can also be arranged in reversed order, e.g. the magnet is fixed to the bracket 48 and the magnetic material to the panel frame 8.

FIG. 8b is a schematic front view of the panels 4 shown in FIG. 8a. The panel frame 8 is at right angles at the upper end and becomes acute towards the lower end. The number of magnetic holders 49 depends on the size and shape of the panels 4.

The use of the framed sliding panels 4 and sliding elements respectively according to this invention obviates the need of cable winches or slide rods. The framed panels 4 can easily slide past each other or be slid together so that they can be used both as a screen and divider and sliding elements in front of shelves, cabinets or niches. Different fabrics or materials of any color or pattern can be used as fabric covering 6 and panels 6′ thus providing a perfect decoration. Since the rail system can be extended and several rails used there are lots of variations which gives particular effect when using different colors and patterns. Similar to picture frames the color design of the structure is unlimited creating visual effects ranging from contrast to matching shades from unobstrusive cool, sober design to country-style colorful appearance. The system is preferably used in lounges, offices but also at practice and hospital rooms, conference rooms and living areas, especially when it comes to large window fronts.

1) Indoor frame-panel system with minimum one holding device (3) at a frame (8) where the holding device (3) is slidable in minimum one rail (2) and the frame (8) has a cross-sectional profile (7) which both takes up an angle (10, 10′) and a fabric covering (6) and/or a panel (6′).

2) Frame-panel system according to claim 1, characterized in that an angle (10, 10′) in a leg (11, 11′) shows a tapped hole (36) receiving a threaded stem (33).

3) Frame-panel system according to claims 1 and 2 characterized in that the frame (8) shows a drilled hole (38) at minimum one point the threaded stem (33) is projecting through.

4) Frame-panel system according to claim 1 characterized in that the rails (2, 2′) are arranged at two sides (39, 39′) of the frame (8).

5) Frame-system according to claim 1 characterized in that the profiled ledges (7, 7′) of the frame (8) are mitered at their ends (9) and jointed by means of an angle (10).

6) Frame-panel system according to claim 1 characterized in that the profiled ledges (7, 7′) of the panels are made of wood, plastic material or meal.

7) Frame-panel system according to claim 1 characterized in that the corner joints of the panel frames are made by pushing the angles (10, 10′) into the profiled ledges (7, 7′).

8) Frame-panel system according to claim 1 characterized in that the profiled ledge (7, 7′) of the frame (8) shows a strap (13) at the side (12) to be covered with fabric (6), which has a saw-tooth profile (15) at its inner surface (14, 15).

9) Frame-panel system according to claims 1 and 8 characterized in that the strap (13) forms a groove (16) together with the adhesive surface (12) of the frame (8) into which the edges of the fabric (6) are inserted.

10) Frame-panel system according to one of the above claims characterized in that the casing (24) of the holding device (3) has a tapped hole (32) at one end where a threaded stem (33) with a cylindrical bolt head (40) engages with the cylindrical bolt head being chamfered (42).

11) Frame-panel system according to one of the above claims characterized in that a threaded stem (33′) engages in tapped hole (32) in casing (24) the bolt head (40′) having the same diameter as the thread (33′).

12) Frame-panel system according to claim 10 characterized in that the chamfer (42) is preferably 45°.

13) Frame-panel system according to claim 10 characterized in that the threaded stem (33, 33′) is locked by a second retaining bolt (41).

14) Frame-panel system according to claim 10 characterized in that the cylindrical bolt head 40,40′) has minimum one plastic material enclosure.

15) Frame-panel system according to claim 10 characterized in that the threaded stem (33, 33′) and the cylindrical bolt head (40, 40′) are made of plastic material.

16) Frame-panel system according to claim 10 characterized in that the bolt head (40) has an hexagonal recess (43).

17) Frame-panel system according to claim 1 characterized in that the longitudinal holding device (3) has minimum one roller (21, 21′) at one end and a screwing for fastening to the frame (8) at the other.

18) Frame-panel system according to claim 17 characterized in that two rollers (21, 21′) are connected by an axle (22) supported in a bearing block (23).

19) Frame-panel system according to claim 17 characterized in that the bearing block (23) is fasted at/in the casing (24) of the holing device 83).

20) Frame-panel system according to claim 17 characterized in that the bolt (25) of the screwing of the holding device (3) is led through a sleeve (26) which can be adjusted with an adjusting screw (27).

21) Frame-panel system according to claim 20 characterized in that the adjusting screw (27) is a grub screw.

22) Frame-panel system according to one of the above claims characterized in that the tapped hole (36) in a leg (11′) of the angle (10, 10′) receives a bolt (37) or a threaded stem (33) of the holding device (3).

23) Frame-panel system according to claim 1 characterized in that a magnet (49, 49′) and/or ferromagnetic material (51, 51′) is provided at minimum one side of the panel frame (8).

24) Frame-panel system according to one of the above claims characterized in that minimum one magnet (49, 49′) forms a magnetic connection with one ferromagnetic material (51, 51′).

25) Frame-panel system according to one of the above claims characterized in that the panels (4) are arranged in the front of shelves, cabinets or niches.

26) Frame-panel system according to one of the above claims characterized in that the different fabric coverings (6) are fastened on the frame (8) with a fastening means which are arranged on the one hand on frame (8) and on the other hand on fabric covering (6).

27) Frame-panel system according to claim 26, characterized in that the fastening means are a Velcro closure and/or a zipper.
